(19) United States
(12) Patent Application Publication
(10) Pub. No.: US 2010/0327506 A1
(43) Pub. Date: Dec. 30, 2010

(54) WINDOW AND DOOR FRAME MACHINING DEVICE

(76) Inventor: Gregg Martin, Winnipeg (CA)

Correspondence Address: ADE & COMPANY INC., 2157 Henderson Highway, WINNIPEG, MB, R2G1P9, CA

(21) Appl. No.: 12/640,728

(22) Filed: Dec. 17, 2009

Related U.S. Application Data
(60) Provisional application No. 61/138,275, filed on Dec. 17, 2008.

(51) Int. Cl. B23Q 1/64

(52) U.S. Cl. 269/56

(57) ABSTRACT

A window or door frame machining device comprises a work holder having a plurality of support rails and a plurality of clamp members supported along the rails for clamping frame members of an assembled perimeter frame onto the work holder. A machining head on a movable support arm is computer controlled by preset instructions arranged to position the clamp members along the respective support rails responsive to the preset instructions corresponding to a configuration of the perimeter frame. In this manner any surface of any frame member can be readily accessed by the machining head by relocating clamp members between different steps in the machining process and no repositioning of the frame is required so as to maintain the frame in a true square configuration while machining. A frame support on the support arm permits both machining and assisting in loading or unloading of the frame by the support arm.

This application claims the benefit under 35 U.S.C. 119(e) of U.S. provisional application Ser. No. 61/138,275, filed Dec. 17, 2008.

### FIELD OF THE INVENTION

The present invention relates to a machining device for machining a perimeter frame belonging to either a window or a door, for example machining mounting apertures for window and door hardware to be mounted on the perimeter frame.

### BACKGROUND

Traditionally, window or door frames made of plastic or metal are manufactured using a series of individual steps involving different workers with different skills sets and using different equipment performing different functions.

A conventional rectangular window or door frame is made of four lengths of elongated frame members joined to each other at the ends to form the rails and stiles of the rectangular window or door frame. For example, the four lengths of elongated frame members of desired dimensions are derived and cut from an original long strip of material as described in U.S. Pat. No. 4,481,701, which are then machined prior to assembly. Machining of each elongated frame member is usually performed on a single work station and conventionally involves the mitering of symmetrical forty-five degree bevel angles at each end of each length as well as the routing and drilling of various holes and slots along the lengths at predetermined positions to accommodate the later incorporation of various hardware items such as latches, locks, roto-gears, hinges and mullions. Subsequently, the four elongated frame members are transferred to a separate work station to be joined to each other at the forty-five degree bevel angles to form a four-corner rectangular window or door frame.

U.S. Pat. No. 7,269,901, to Robin, discloses a method of manufacturing a window or door frame. A machining device accommodates frame members already assembled into a window or door frame to reduce wasted materials resulting from frame assembly errors. The clamping members disclosed may require multiple machining heads to access all surfaces of the frame and may further require repositioning of the frame relative to the clamping members.

### SUMMARY OF THE INVENTION

According to one aspect of the invention there is provided a frame machining device for machining a perimeter frame belonging to either a window or a door and being formed of elongated frame members joined to one another at respective corners of the perimeter frame, the device comprising:

a work holder comprising a plurality of support rails supported for movement relative to one another and a plurality of clamp members supported for movement along the rails so as to be arranged for clamping the frame members of the perimeter frame onto the work holder;

a machining head arranged for supporting a machining tool therein;

a movable support arm supporting the machining head thereon;

the movable support arm being movable relative to the work holder such that the machining head is arranged to operably engage the frame members of the perimeter frame;

a computer controller having preset instructions and being arranged to position the clamp members along the respective support rails responsive to the preset instructions corresponding to a configuration of the perimeter frame.

By providing clamp members which movable along respective rails responsive to preset instructions of a computer controller, any surface of any frame member can be readily accessed by the machining head by relocating clamp members between different steps in the machining process. In this manner, no repositioning of the frame is ever required to permit most efficient use of the machining head. Furthermore, the clamp members can be positioned in an optimal location to maintain the frame in a true square configuration relative to each different machining location on the frame.

When the preset instructions of the computer controller includes location data relating to engagement of the machining head with the perimeter frame, the computer controller may be arranged to reposition the clamp members so as not to interfere with the location data of the machining head.

When the location data comprises a plurality of machining operations at different locations on the perimeter frame, the computer controller is preferably arranged to reposition the clamp members between at least some of the machining operations on the perimeter frame.

When the location data comprises a plurality of machining operations at different locations on the perimeter frame, the computer controller is preferably arranged to position the clamp members in a common configuration during only some of the machining operations.

The computer controller is preferably arranged to position clamp members which are arranged to clamp frame members opposite the location data of the machining head to be adjacent respective corners of the perimeter frame.

The computer controller is preferably arranged to position at least one clamp member adjacent the location data of the machining head.

The computer controller is preferably arranged to position the clamp members prior to supporting the perimeter frame on the work holder.

The computer controller is preferably arranged to position only some of the clamp members to engage the perimeter frame and is also preferably arranged to position all of the clamp members to engage other perimeter frames of differing configuration.

The work holder is preferably arranged to support the perimeter frame wholly on the clamp members which are supported for movement along the rails.

The computer controller is preferably arranged to sense a configuration of the frame and compare the sensed configuration to the preset instructions prior to machining the perimeter frame with the machining head.

There may be provided a sensor switch on at least one of the clamp members arranged to engage the perimeter frame to sense the configuration of the frame.

Preferably there is provided a sensor switch on at least two clamp members arranged to engage respective adjacent ones of the frame members of the perimeter frame to sense the configuration of the frame.

Preferably there is provided a motor arranged to displace at least some of the clamp members along the respective rails in which there is provided a sensor switch associated with at least one of the motors which is arranged to sense the configuration of the frame.

The support arm preferably comprises a robotic arm having a base member and being arranged such that the machining head is arranged for movement about 6 axes relative to the base member so as to engage each of the frame members along a full length thereof.

When there is provided a front surface machining tool and a rear surface machining tool arranged to be interchangeably supported on the machining head relative to one another, the front surface machining tool is preferably arranged to engage a front side of each frame member in a common front side plane of the perimeter frame and the rear surface machining tool being arranged to engage a rear side of each frame member in a common rear side plane of the perimeter frame.

The support rails preferably include a first fixed rail, a first movable rail oriented parallel to the first fixed rail and supported for movement at an adjustable spacing relative to the first fixed rail, a second fixed rail oriented perpendicularly to the first fixed rail, and a second movable rail oriented parallel to the second fixed rail and supported for movement at an adjustable spacing relative to the second fixed rail.

The first movable rail and the second movable rail are preferably coupled to one another for relative sliding movement in two perpendicular directions.

Preferably at least one of the clamp members is supported on the each of the second fixed rail and the second movable rail for movement in a retracting direction between a working position and a retracted position across a plane of movement of the first movable rail.

Each clamp member preferably comprises two first clamping surfaces oriented perpendicularly in fixed relation to one another and being arranged to engage an outer side and a common rear side of the perimeter frame respectively and at least one second clamping surface arranged to confront a respective one of the first clamping surfaces.

Preferably said at least one second clamping surface is supported for movement at an adjustable spacing relative to the respective first clamping surface so as to be arranged to clamp one of the frame members of the perimeter frame therebetween.

Preferably said at least one second clamping surface comprises a pair of second clamping surfaces, each being movable relative to a respective opposing one of the first clamping surfaces in a linear direction along a respective clamping axis and being rotatable relative to the opposing one of the first clamping surfaces about the clamping axis between a clamping position in alignment with the first clamping surface so as to be arranged to overlap the perimeter frame and an offset position in which the second clamping surface is not aligned with the first clamping surface such that the perimeter frame is readily releasable from the clamp member.

When there is provided a frame support mounted on the support arm and arranged to support the perimeter frame thereon when the perimeter frame is released from the clamp members, preferably the frame support is movable with the support arm between a working position arranged to support the perimeter frame thereon in engagement with the clamp members and a released position arranged to support the perimeter frame thereon separate from the work holder.

According to a second aspect of the present invention there is provided a frame machining device for machining a perimeter frame belonging to either a window or a door and being formed of elongated frame members joined to one another at respective corners of the perimeter frame, the device comprising:

a work holder comprising a plurality of clamp members arranged for clamping the frame members of the perimeter frame onto the work holder;

a machining head arranged for supporting a machining tool therein;

a movable support arm supporting the machining head thereon;

the movable support arm being movable relative to the work holder;

a computer controller arranged to control movement of the movable support arm such that the machining tool is arranged to operably engage the frame members of the perimeter frame; and

a frame support mounted on the support arm and arranged to support the perimeter frame thereon when the perimeter frame is released from the clamp members;

the frame support being movable with the support arm between a working position arranged to support the perimeter frame thereon in engagement with the clamp members and a released position arranged to support the perimeter frame thereon separate from the work holder.

Providing a frame support on the support arm together with the machining head permits a single computer controlled member to both machine the surfaces of the frame and assisting in loading or unloading of the frame. The machining process is thus simplified for savings of time and cost as compared to prior art window and door frame machining devices.

The frame support may be supported adjacent the machining tool.

The frame support may be spaced from the work holder in the released position.

The frame support preferably comprises a hook member arranged to suspend the perimeter frame therefrom.

The frame support may comprise a supporting surface arranged to support the perimeter frame thereon in which the supporting surface is arranged to be substantially horizontal in the released position.

There may be provided a clamp member on the frame support arranged to clamp the perimeter frame to the support arm.

The frame support preferably comprises a supporting surface arranged to face upwardly in the released position to support the perimeter frame thereon, a first clamping surface extending upwardly from the supporting surface in the released position so as to be arranged to retain the perimeter frame on the supporting surface, and a second clamping surface extending upwardly from the supporting surface at an adjustable spacing relative to the first clamping surface so as to be arranged to clamp the perimeter frame between the first and second clamping surfaces.

One embodiment of the invention will now be described in conjunction with the accompanying drawings in which:

### BRIEF DESCRIPTION OF THE DRAWINGS

FIG. 1 is a schematic representation of the frame machining device.

FIG. 2 is a schematic representation of the work holder of the frame machining device.

FIG. 3 is a schematic representation of the interaction between the various components of the frame machining device.

FIG. 4 is a perspective view of the machining head support arm of the frame machining device.

FIG. 5 is a perspective view of one of the clamp members of the frame machining device.

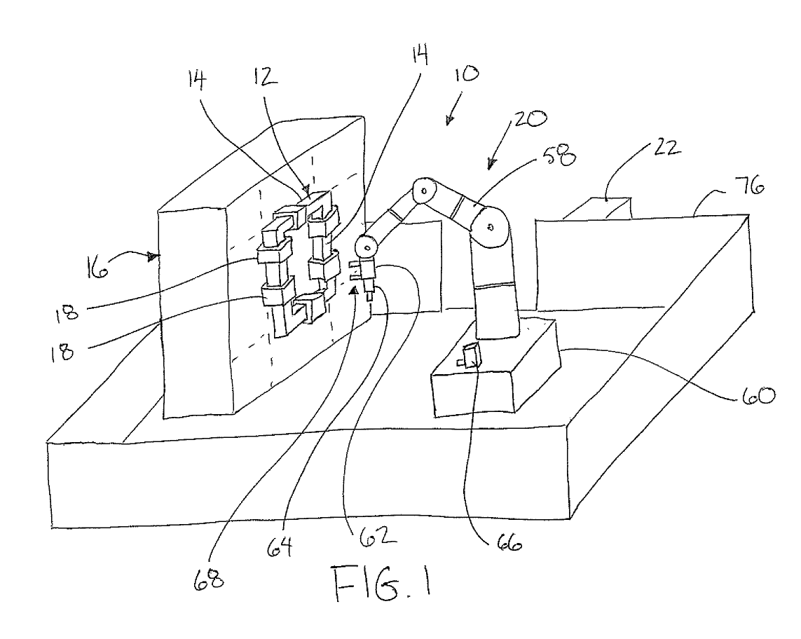

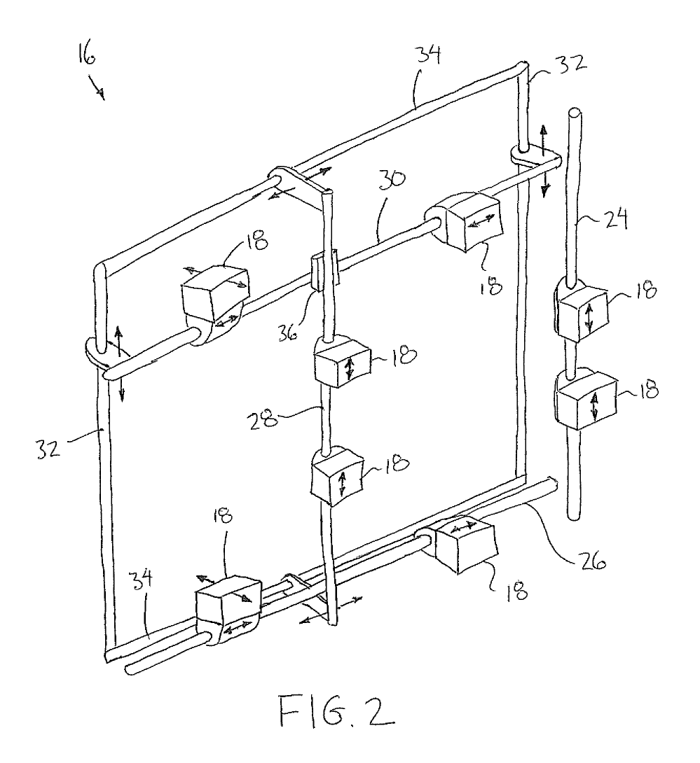

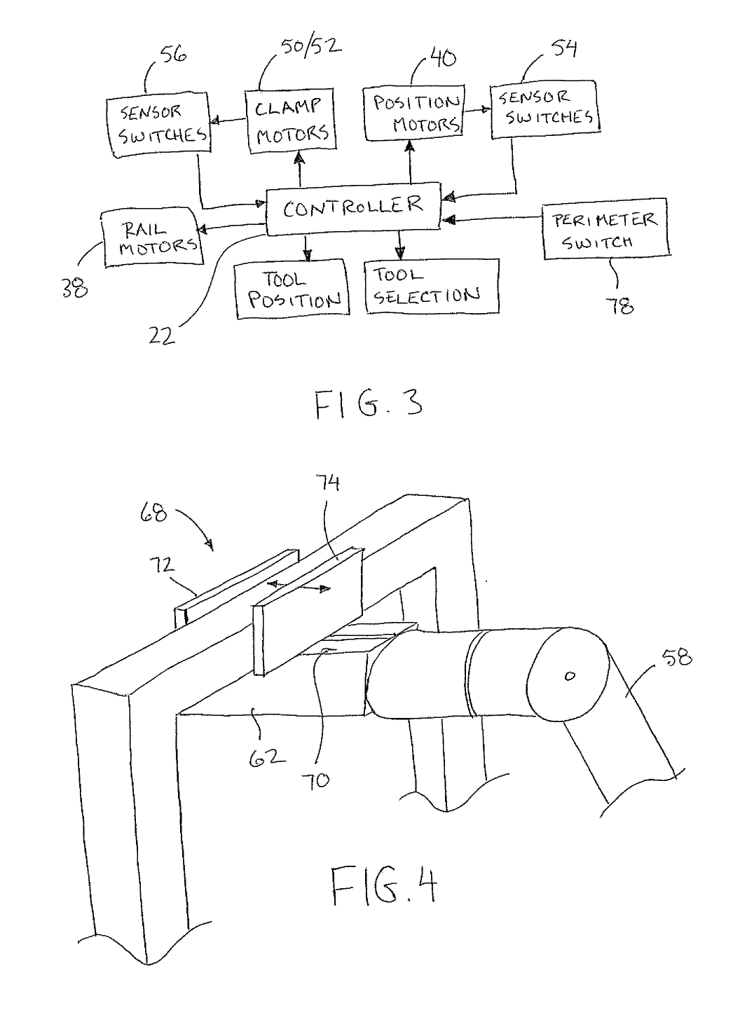

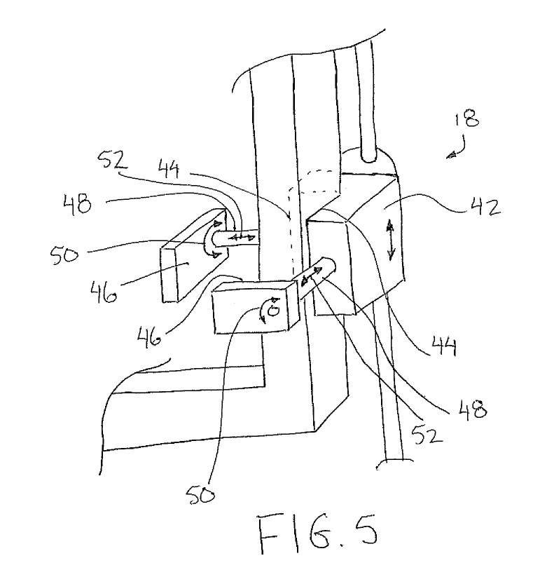

In the drawings like characters of reference indicate corresponding parts in the different figures.

### DETAILED DESCRIPTION

Referring to the accompanying figures there is illustrated a frame machining device generally indicated by reference numeral 10. The device 10 is particularly suited for machining a perimeter frame 12 of a window or a door, for example for mounting various hardware to the perimeter frame 12 or for forming drain apertures, etc and the like.

A typical frame 12 comprises a plurality of frame members 14, typically in a rectangular configuration with the frame members 14 being joined with one another at respective corners of the perimeter frame where the frame members are joined perpendicularly with one another. The frame members typically comprise an extruded profile of plastic or metal, for example PVC or aluminum, which are joined at the corners by welding.

The device 10 generally comprises a work holder 16 comprising a plurality of clamp members 18 arranged to support the perimeter frame 12 thereon, a machining assembly 20 for performing various machining operations on the frame members of the perimeter frame 12, and a computer controller 22 arranged to control the clamp members 18 and the machining assembly 20 according to preset instructions so as to position the clamp members and the machining assembly relative to the frame 12 according to the configuration of the frame and the desired machining operation locations to be performed thereon.

The work holder 16 generally comprises a set of four support rails comprising a first fixed rail 24, a second fixed rail 26, a first movable rail 28 and a second movable rail 30. The four support rails are supported in a generally rectangular configuration in an upright orientation for receiving the perimeter frame 12 of the window or door in an upright orientation between the support rails. The first and second fixed rails are joined with one another in fixed relationship to be oriented perpendicularly so that the first fixed rail extends generally vertically while the second fixed rail extends horizontally adjacent a bottom end of the first fixed rail. The first fixed rail is situated towards one end of the second fixed rail so that the fixed rails extend along one side and across the bottom of the perimeter frame respectively.

The first movable rail 28 is oriented vertically so as to be parallel to the first fixed rail to extend along an opposing side of the perimeter frame 12 received therebetween. The first movable rail 28 is supported on respective tracks 32 which extend horizontally parallel to the second fixed rail so that the first movable rail 28 can be supported thereon at respective top and bottom ends for movement towards and away from the first fixed rail 24.

The second movable rail 30 is supported parallel and spaced above the second fixed rail 26 and is similarly supported at opposing ends on respective tracks 34 extending vertically so as to be parallel to the first fixed rail 24. The second movable rail 30 is movable alone the respective tracks at the opposing ends thereof so as to remain parallel at an adjustable spacing relative to the second fixed rail 26 therebelow.

The first and second movable rails each include a respective track formed therealong for sliding connection to a coupling element 36 which is slidable along both tracks so that the first and second movable rails remain coupled to one another through the coupling element 36 for additional structural support. The movable rails remain slidable relative to one another along an axis of each movable rail so as to be coupled for relative sliding movement in two perpendicular direction as the movable rails are slidably displaced at an adjustable spacing relative to the respective fixed rails 24 and 26.

Motors 38 are coupled to each respective movable rail 28 and 30 for controlling the movement and position thereof relative to the respective fixed rail. The motors 38 may comprise stepper motors providing accurate positional control of the spacing between each movable rail and its respective fixed rail. Adjusting the spacing between the rails permits the clamp members 18 to be secured about the perimeter of the frame 12 regardless of the size of the frame as the spacing between the first rails and second rails respectively can be adjusted to accommodate the height and width of the frame respectively.

Two of the clamp members 18 are supported on each rail for sliding movement therealong along a longitudinal direction of the rail. Each clamp member 18 includes a respective position motor 40 which controls movement of the clamp member along the respective rail. The position motor 40 typically comprises a stepper motor providing accurate positional control of the clamp member at any one of numerous positions along a length of the rail.

Each clamp member 18 comprises a clamp body 42 supporting a pair of first clamping surfaces 44 in fixed relationship thereon. The first clamping surfaces 44 are arranged in an L-shaped configuration so as to be oriented perpendicularly to one another. One of the first clamping surfaces 44 is arranged to lie in a substantially common plane with the corresponding first clamping surface 44 of the other clamp members so as to be arranged to engage a common rear side of the perimeter frame 12 positioned thereagainst.

The other one of the first clamping surfaces 44 of each clamp member is arranged to face inwardly towards the clamp member on the opposing side of the perimeter frame so that the other one of the first clamping surfaces of each clamp member is arranged to engage an outer side of the perimeter frame facing outwardly away from the opposing side of the frame. Positioning of the rails relative to one another permits the inward facing ones of the first clamping surfaces 44 on opposing sides of the perimeter frame 12 to clamp the perimeter frame 12 therebetween.

Each clamp member 18 also includes a pair of second clamping surfaces 46 mounted parallel and opposite respective ones of the first clamping surfaces 44 so that each clamp member defines two pairs of confronting clamping surfaces arranged to clamp about all four sides of a frame member having a substantially rectangular cross section. Each second clamping surface 46 is thus arranged to be parallel and spaced apart from a respective one of the first clamping surfaces 44. Each second clamping surface 46 is supported on a respective post 48 which extends perpendicularly outward relative to the corresponding opposing first clamping surface 44.

The second clamping surfaces 46 are each supported on the respective post 48 so as to be movable in a linear direction along the post so that the spacing between the confronting pairs of clamping surfaces is adjustable. Each second clamping surface is also supported for rotation about the axis of the post 48 between a clamping positioning in alignment with the respective opposing first clamping surface 44 to overlap the perimeter frame clamped therebetween and an offset position in which the second clamping surface is offset in relation to the corresponding opposing first clamping surface so that the clamping surfaces do not align with one another and the perimeter frame 12 is readily releasable from the clamp member.

Each clamp member thus includes one second clamping surface 46 which is arranged in a common plane as all of the other corresponding second clamping surfaces of the other clamp members for engaging a common front side of the perimeter frame. The other one of the second clamping surfaces of each clamp member is arranged for engaging an inner surface of each frame member which faces inwardly towards the opposing frame member of the perimeter frame. The other one of the second clamping surfaces 46 of each clamp member is thus arranged for clamping the inner side of the frame member which is parallel to and confronting the inner side of the opposing frame member.

Each second clamping surface 46 of each clamp member includes a first clamp motor 50 controlling pivotal movement of the clamping surface about the axis of the respective post 48 upon which it is supported for movement between the clamping position and the offset position relative to the perimeter frame and a second clamp motor 52 which controls the position of the clamping surface 46 in a linear direction along the axis of the post 48 upon which it is supported for adjusting and controlling spacing and distance between the second clamping surface and the corresponding first clamping surface 44.

The first movable rail 28 is movable within a plane spaced forwardly of a plane of movement of the second movable rail 30 and second fixed rail 26. When the clamp members are positioned for sliding movement along respective front sides of the rails, movement of the clamp members along the first movable rail 28 is not impeded by the second movable rail 30 positioned rearwardly thereof. However, movement of the clamp members along the second movable rail 30 and the second fixed rail 26 may cause interference with the first movable rail 28 also movable along the front side of the second movable rail and second fixed rail.

Accordingly, the clamp member farthest from the first fixed rail on each of the second fixed rail and second movable rail are supported for movement across a plane of movement of the first movable rail, rearwardly in a retracting direction between a working position positioned forwardly of the respective rail upon which it is supported so as to interfere with movement of the first movable rail relative to the first fixed rail and a retracted position in which the clamp member is positioned rearwardly of the first movable rail 28 so as not to interfere with movement of the first movable rail relative to the first fixed rail. The clamp member nearest to the first fixed rail on each of the second fixed rail and second movable rail is not required to be movable in the retraction direction as at least one clamp member on each of the second rails remains between the first rails when clamping onto a frame supported on the work holder as at least one clamp member engages all four sides of the perimeter frame in a working position.

All of the motors associated with the clamp members are controlled by the computer controller 22 so that the computer controller is arranged to control the position of each clamp member, the open and closing clamping action and actuation thereof for clamping a frame member therein. In addition to position of the clamp members along the rails, the computer controller also controls the position of the rails relative to one another to closely match the height and width of a perimeter frame to be received within the work holder. The position of the rails and the starting position and number of clamp members to be engaged on the perimeter frame are all determined prior to loading of a perimeter frame onto the work holder by following the preset instructions of the computer controller which correspond to the particular configuration of perimeter frame to be loaded next onto the work holder.

Once the clamp members are initially positioned, a frame can be loaded onto the clamp members with the second clamping surfaces 46 being in a release position spaced outwardly from the opposing first clamping surface and rotated into the offset position. A machining operation begins by first closing all of the second clamping surfaces towards the respective first clamping surfaces to clamp the frame members therebetween. The perimeter frame is arranged to be supported wholly by the clamp members at particular locations spaced apart about the perimeter of the frame 12.

Each frame configuration includes preset instructions which indicate a series of machining operations to be performed on the frame including a location of each machining operation, in which the location data of the machining operations are provided in the form of preset instructions loaded onto the computer controller 22 before loading of the frame onto the clamp members. By providing the computer controller with location data relating to the engagement of the machining tool of the machining assembly with the perimeter frame for each machining operation, the computer controller is arranged to reposition the clamp members so as not to interfere with the location data of the machining tool between at least some of the machining operations on the perimeter frame so that the computer controller is arranged to position the clamp members in a common configuration during only some of the machining operations on each particular perimeter frame 12.

The clamp members are positioned about the perimeter frame 12 for each machining operation on the frame at locations which best secure the perimeter frame against forces from the machining operation which might cause the frame members to deviate from a true and square or rectangular configuration. The optimal location to counter machining forces and maintain the frame square typically will vary for each different machining operation location on the perimeter frame. Commonly at least one clamp member is positioned adjacent the machining operation location on the same frame member. On the frame member opposite the machining operation location, the clamp members are typically located adjacent the corners of the frame member with adjacent frame members to maintain the corners of the perimeter frame in the optimal square orientation. The clamp members along the frame members adjacent to the frame member upon which a machining operation is taking place are also typically located nearest the corners where the frame members join adjacent frame members also to maintain position of the corners in a true square configuration despite asymmetrical machining forces being applied to one of the frame members.

Prior to any machining taking place on a particular perimeter frame 12 loaded onto the work holder, the computer controller 22 performs checks with regard to one or various configurations of the frame loaded onto the work holder to ensure that the measured characteristics of the frame correspond with the configuration of the frame identified by the preset instructions loaded into the computer controller. This ensures that a correct configuration of perimeter frame is supported in the work holder prior to attempting to perform any machining operations on the perimeter frame.

In particular a first sensor switch 54 is provided in association with each motor which positions the rails and clamp members. If an improperly sized perimeter frame is loaded into the work holder which does not correspond to the identified configuration or dimensions of the perimeter frame associated with the preset instructions, some of the motors will require an excess or abnormal amount of torque to attempt to properly position the clamp members with the excess torque being detectable by the first sensor switches 54. Upon actuation of one of the first sensor switches 54, an error signal is sent to the computer controller 22 which aborts any further machining operations to be performed until an operator reconfirms the size and configuration of the perimeter frame 12 to be machined.

Several of the clamp members are also provided with second sensor switches 56 which are arranged to engage the perimeter frame and be actuated by the perimeter frame in the event that the perimeter frame is oversized relative to the expected configuration of perimeter frame 12 defined in the preset instructions of the computer controller. Actuation of any one of the micro switches defining the second sensor switches 56 similarly sends an error signal to the computer controller to abort any further machining operations until the size and configuration of the perimeter frame is confirmed by the operator.

If no error signals from sensor switches are received by the computer controller during actuation of the clamp members to clamp the perimeter frame into a working position on the work holder, then the computer controller 22 proceeds to instruct the machining assembly to proceed with the various machining operations to be performed on the perimeter frame. Typically at least one of the clamp members on one of the first rails is provided with a second sensor switch 56 and at least one of the clamp members on at least one of the second rails is provided with a second sensor switch 56 thereon so that the sensor switches are arranged to check the dimensions of the perimeter frame in two perpendicular directions.

The machining assembly 20 comprises a robotic support arm 58 supported on a base 60 fixed on the ground similarly to the work holder at a position spaced outwardly and forwardly therefrom. A free end of the robotic support arm supports a machining head 62 thereon which receives various machining tools interchangeably therein for operably engaging and machining the surfaces of the frame members of the perimeter frame 12 supported in the work holder. The support arm 58 includes a plurality of joints between the base 60 and the machining head 62 at the free end thereof which are controlled by the computer controller 22. In particular the robotic support arm includes three sections hinged relative to one another about respective axes in which each of the sections is further rotatable about a respective longitudinal axis thereof so that the machining head 62 is rotatable about six axes relative to the base 60 to position the machining head and the machining tool supported therein at any one of an infinite number of positions in space occupied by a perimeter frame supported on the work holder.

More particularly the machining head 62 is arranged to support a front machining tool 64 and a rear machining tool 66 interchangeably therein. The front machining tool is arranged for engaging and machining a front surface or front side of each frame member lying in a generally common front side plane of the perimeter frame as well as being arranged to engage inner and outer surfaces of each frame member facing inwardly towards and outwardly away from an opposing one of the frame members respectively. The rear machining tool 66 is arranged to be oriented at right angles as compared to the front machining tool 64 and is arranged to be positioned for engaging and machining a rear side or rear surface of each frame member of the perimeter frame which lies in a common rear side plane of the perimeter frame. The rear machining tool is also arranged to engage the inner and outer sides of each frame member.

An outermost section of the robotic support arm 58 adjacent to the machining head and machining tool supported therein at the free end of the support arm includes a frame support 68 mounted thereon which is arranged to support and suspend the perimeter frame therefrom when loading or unloading the perimeter frame from the work holder. The frame support 68 includes a primary supporting surface 70 which extends generally in the longitudinal direction of the support arm 58 along a top side thereof so as to be arranged to be positioned horizontally in loading and release positions of the frame support. The level and horizontal orientation of the supporting surface 70 is arranged to be supported directly below an uppermost horizontal one of the frame members of the perimeter frame so that upon release of the clamp members the frame member at the top of the perimeter frame will be engaged upon the supporting surface 70 and freely suspended therefrom when the frame support 68 is centrally located along the frame member.

To assist retaining the frame member on the supporting surface 70 of the frame support 68 a first clamping surface is provided in the form of a hook member 72 which extends perpendicularly upward from the supporting surface 70 nearest the free end locating the machining head of the support arm so as to prevent the perimeter frame from sliding off the supporting surface towards the free end of the robotic support arm.

The frame support 68 further comprises a second clamping surface in the form of a clamping member 74 which also extends perpendicularly upward from the supporting surface 70 in both the released and loading positions of the frame support. The hook member 72 and clamp members 74 comprise flat inner clamping surfaces which confront one another at an adjustable spacing therebetween while remaining parallel to one another as the clamp member 74 is movable in a longitudinal direction of the support arm towards and away from the hook member 72 to effectively clamp the upper frame member of the perimeter frame between the first and second surfaces when the clamp member 74 is actuated into a clamping position towards the hook member 72. The clamp member 74 is displaced away from the hook member 72 to increase the spacing therebetween and release the clamping force on the frame member therebetween when unloading the frame member from the frame support.

Upon completion of the machining operations, the clamp member 74 is displaced away from the hook member 72 into a released position of the clamp member and the supporting surface 70 is positioned directly below the upper one of the frame members of the perimeter frame centrally therealong so that when the clamp members of the work holder are released the frame will be engaged upon the supporting surface of the frame support to be suspended therefrom. Closing the clamp member 74 towards the hook member 72 into a clamped position of the frame member therebetween ensures that the perimeter frame remains secured in the frame support as the support arm is displaced from a loading position at the work holder to a released or unloading position spaced apart from the work holder close to the base of the supporting arm.

In the unloading position, the clamp member 74 can again be released so that an operator can simply lift the perimeter frame off of the supporting surface 70 of the frame support to unload a finished and machined perimeter frame from the frame machining device.

A gated enclosure 76 is provided about both the work holder and the robotic support arm of the machining assembly 20 to ensure that the machining device is only operated when the surrounding gated area is clear of an operator. Suitable perimeter switches 78 are provided which monitor whether there is a person within the gated area 76 to prevent the operation of the machining assembly in the event that an occupant is in the area. The operator can enter the gated area for loading perimeter frames onto the work holder, and subsequently unloading perimeter frames from the frame support 68 of the machining assembly spaced apart from the work holder.

In use, an operator initially inputs various characteristics relating to the configuration of the perimeter frame being machined prior to loading the frame onto the work holder. The frame configuration is translated into preset instructions for the computer controller 22 which then suitably operates the machine assembly 20 and the position of the clamp members to adequately secure the perimeter frame during each machining operation without interfering with any of the machining operations.

Typical characteristics of a perimeter frame to be entered initially comprise identifying the profile of the frame members and the type of window or door with which the perimeter frame is to be associated, for example a casing window, an awning window, sliding window, and any divider locations between fixed and sliding panes for example. Which part of the window or door frame that the perimeter frame comprises is then entered, for example to determine if the perimeter frame 12 corresponds to an outer frame or a sash. Subsequently various setting options are entered including the type of hardware to be attached, and either left or right hand configurations or vertical or horizontal configurations of the hardware.

Upon entering the height and width of the perimeter frame, the computer controller can then be arranged to automatically determine the number of each hardware component to be added. Any override options can subsequently be entered. Once all of the characteristics of the frame have been entered, the perimeter frame is in queue for machining by the frame machining device 10. In some embodiments all of the frame characteristics may already by provided in a computer readable form, for example a barcode and the like which can be scanned by the computer controller to automatically determine the preset instructions without a plurality of selections being required on the part of the user. Alternatively a user interface is provided where an operator can enter all of the frame characteristics into the computer controller 22.

When a particular perimeter frame 12 is queued up to be the next frame ready for machining, the operator positioned the perimeter frame on the open clamp members which have already been positioned in a starting position by the preset instructions of the computer controller. Upon placing the perimeter frame on the clamp members in respective open positions and upon exiting the gated area of the device, the clamp members will be closed to begin the first machining operation.

The clamps are repositioned for each machining operation on the perimeter frame by displacing the clamp members along the respective support rails and responsive to the preset instructions of the computer controller which correspond to the configuration of the perimeter frame. The computer controller further selects the tools for the machining head for each machining operation and the position and orientation of the robotic support arm to effect the machining at each machining operation location.

Prior to machining, the sensor switches confirm that the perimeter frame loaded onto the work holder corresponds with the frame configuration identified in the preset instructions of the computer controller. When changing between two different widths of perimeter frames which would be supported either by one or two clamp members along the horizontal frame members thereof, the clamp member on each of the second rails farthest from the first fixed rail can be retracted into the retracted position relative to the first movable rail to permit the clamp members on the first movable rail to be positioned against the respective side of the perimeter frame for each different size of frame. For each frame loaded onto the work holder, and for each machining operation on each frame, the clamp members are always positioned for optimally maintaining the frame in a square configuration which resists any deforming from forces applied to the frame by machining operations.

Additional machining operations may include cleaning the welds at the corners of the perimeter frame where two frame members are welded together by providing an additional cleaning machining tool which is interchangeably supported in the machining head similarly to the front and rear machining tools.

In some machining operations when machining into a double walled profile of frame member, the machining tool may be arranged in the respective machining head to first form an outer aperture in the outermost wall of the frame member profile prior to machining an inner wall of the profile so that the corresponding aperture in the inner wall of the profile is machined in a second stage after the outer aperture is already completed.

In further embodiments multiple machining operations may be performed on different frame members of a given perimeter frame at the same time by providing more than one machining assembly arranged to engage the perimeter frame. The computer controller in this instance would be arranged to determine the preset instructions for each machining assembly to best ensure there is no interference between the two machining assembles and to ensure that the clamp members can be optimally positioned for two simultaneous machining operations without interfering with either machining operation and while also bracing against the external forces applied by both machining operations to maintain the frame in a square configuration.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A frame machining device for machining a perimeter frame belonging to either a window or a door and being formed of elongated frame members joined to one another at respective corners of the perimeter frame, the device comprising:
a work holder comprising a plurality of support rails supported for movement relative to one another and a plurality of clamp members supported for movement along the rails so as to be arranged for clamping the frame members of the perimeter frame onto the work holder;
a machining head arranged for supporting a machining tool therein;
a movable support arm supporting the machining head thereon;
the movable support arm being movable relative to the work holder such that the machining head is arranged to operably engage the frame members of the perimeter frame;
a computer controller having preset instructions and being arranged to position the clamp members along the respective support rails responsive to the preset instructions corresponding to a configuration of the perimeter frame.

2. The device according to claim 1 wherein the preset instructions of the computer controller include location data relating to engagement of the machining head with the perimeter frame and wherein the computer controller is arranged to reposition the clamp members so as not to interfere with the location data of the machining head.

3. The device according to claim 2 wherein the location data comprise a plurality of machining operations at different locations on the perimeter frame and wherein the computer controller is arranged to reposition the clamp members between at least some of the machining operations on the perimeter frame.

4. The device according to claim 2 wherein the location data comprises a plurality of machining operations at different locations on the perimeter frame and wherein the computer controller is arranged to position the clamp members in a common configuration during only some of the machining operations.

5. The device according to claim 2 wherein the computer controller is arranged to position clamp members which are arranged to clamp frame members opposite the location data of the machining head to be adjacent respective corners of the perimeter frame.

6. The device according to claim 2 wherein the computer controller is arranged to position at least one clamp member adjacent the location data of the machining head.

7. The device according to claim 1 wherein the computer controller is arranged to position the clamp members prior to supporting the perimeter frame on the work holder.

8. The device according to claim 1 wherein the computer controller is arranged to position only some of the clamp members to engage the perimeter frame and is arranged to position all of the clamp members to engage other perimeter frames of differing configuration.

9. The device according to claim 1 wherein the work holder is arranged to support the perimeter frame wholly on the clamp members which are supported for movement along the rails.

10. The device according to claim 1 wherein the computer controller is arranged to sense a configuration of the frame and compare the sensed configuration to the preset instructions prior to machining the perimeter frame with the machining head.

11. The device according to claim 10 wherein there is provided a sensor switch on at least one of the clamp members arranged to engage the perimeter frame to sense the configuration of the frame.

12. The device according to claim 10 wherein there is provided a sensor switch on at least two clamp members arranged to engage respective adjacent ones of the frame members of the perimeter frame to sense the configuration of the frame.

13. The device according to claim 10 wherein there is provided a motor arranged to displace at least some of the clamp members along the respective rails and wherein there is provided a sensor switch associated with at least one of the motors which is arranged to sense the configuration of the frame.

14. The device according to claim 1 wherein the support arm comprises a robotic arm having a base member and being arranged such that the machining head is arranged for movement about 6 axes relative to the base member so as to engage each of the frame members along a full length thereof.

15. The device according to claim 1 wherein there is provided a front surface machining tool and a rear surface machining tool arranged to be interchangeably supported on the machining head relative to one another, the front surface machining tool being arranged to engage a front side of each frame member in a common front side plane of the perimeter frame and the rear surface machining tool being arranged to engage a rear side of each frame member in a common rear side plane of the perimeter frame.

16. The device according to claim 1 wherein the support rails include a first fixed rail, a first movable rail oriented parallel to the first fixed rail and supported for movement at an adjustable spacing relative to the first fixed rail, a second fixed rail oriented perpendicularly to the first fixed rail, and a second movable rail oriented parallel to the second fixed rail and supported for movement at an adjustable spacing relative to the second fixed rail.

17. The device according to claim 16 wherein the first movable rail and the second movable rail are coupled to one another for relative sliding movement in two perpendicular directions.

18. The device according to claim 16 wherein at least one of the clamp members is supported on the each of the second fixed rail and the second movable rail for movement in a retracting direction between a working position and a retracted position across a plane of movement of the first movable rail.

19. The device according to claim 1 wherein each clamp member comprises two first clamping surfaces oriented perpendicularly in fixed relation to one another and being arranged to engage an outer side and a common rear side of the perimeter frame respectively and at least one second clamping surface arranged to confront a respective one of the first clamping surfaces, said at least one second clamping surface being supported for movement at an adjustable spacing relative to the respective first clamping surface so as to be arranged to clamp one of the frame members of the perimeter frame therebetween.

20. The device according to claim 20 wherein said at least one second clamping surface comprises a pair of second clamping surfaces, each being movable relative to a respective opposing one of the first clamping surfaces in a linear direction along a respective clamping axis and being rotatable relative to the opposing one of the first clamping surfaces about the clamping axis between a clamping position in alignment with the first clamping surface so as to be arranged to overlap the perimeter frame and an offset position in which the second clamping surface is not aligned with the first clamping surface such that the perimeter frame is readily releasable from the clamp member.

21. The device according to claim 1 wherein there is provided a frame support mounted on the support arm and arranged to support the perimeter frame thereon when the perimeter frame is released from the clamp members, the frame support being movable with the support arm between a working position arranged to support the perimeter frame thereon in engagement with the clamp members and a released position arranged to support the perimeter frame thereon separate from the work holder.

22. The device according to claim 21 wherein the frame support is supported adjacent the machining tool.

23. The device according to claim 21 wherein the frame support is spaced from the work holder in the released position.

24. The device according to claim 21 wherein the frame support comprises a hook member arranged to suspend the perimeter frame therefrom.

25. The device according to claim 21 wherein the frame support comprises a supporting surface arranged to support the perimeter frame thereon, the supporting surface being arranged to be substantially horizontal in the released position.

26. The device according to claim 21 wherein there is provided a clamp member on the frame support arranged to clamp the perimeter frame to the support arm.

27. The device according to claim 21 wherein the frame support comprises a supporting surface arranged to face upwardly in the released position to support the perimeter frame thereon, a first clamping surface extending upwardly from the supporting surface in the released position so as to be arranged to retain the perimeter frame on the supporting surface, and a second clamping surface extending upwardly from the supporting surface at an adjustable spacing relative to the first clamping surface so as to be arranged to clamp the perimeter frame between the first and second clamping surfaces.

28. A frame machining device for machining a perimeter frame belonging to either a window or a door and being formed of elongated frame members joined to one another at respective corners of the perimeter frame, the device comprising:
a work holder comprising a plurality of clamp members arranged for clamping the frame members of the perimeter frame onto the work holder;
a machining head arranged for supporting a machining tool therein;
a movable support arm supporting the machining head thereon;
the movable support arm being movable relative to the work holder;
a computer controller arranged to control movement of the movable support arm such that the machining tool is arranged to operably engage the frame members of the perimeter frame; and
a frame support mounted on the support arm and arranged to support the perimeter frame thereon when the perimeter frame is released from the clamp members;
the frame support being movable with the support arm between a working position arranged to support the perimeter frame thereon in engagement with the clamp members and a released position arranged to support the perimeter frame thereon separate from the work holder.

29. The device according to claim 28 wherein the frame support is supported adjacent the machining tool.

30. The device according to claim 28 wherein the frame support is spaced from the work holder in the released position.

31. The device according to claim 28 wherein the frame support comprises a hook member arranged to suspend the perimeter frame therefrom.

32. The device according to claim 28 wherein the frame support comprises a supporting surface arranged to support the perimeter frame thereon, the supporting surface being arranged to be substantially horizontal in the released position.

33. The device according to claim 28 wherein there is provided a clamp member on the frame support arranged to clamp the perimeter frame to the support arm.

34. The device according to claim 28 wherein the frame support comprises a supporting surface arranged to face upwardly in the released position to support the perimeter frame thereon, a first clamping surface extending upwardly from the supporting surface in the released position so as to be arranged to retain the perimeter frame on the supporting surface, and a second clamping surface extending upwardly from the supporting surface at an adjustable spacing relative to the first clamping surface so as to be arranged to clamp the perimeter frame between the first and second clamping surfaces.
